(19) United States
(12) Patent Application Publication
(10) Pub. No.: US 2012/0096372 A1
(43) Pub. Date: Apr. 19, 2012

(54) System For Creating, Deploying, And Updating Applications And Publications For Mobile Devices

(76) Inventor: Jordan Stolper, Brooklyn, NY (US)

(21) Appl. No.: 13/273,538

(22) Filed: Oct. 14, 2011

Related U.S. Application Data
(60) Provisional application No. 61/393,671, filed on Oct. 15, 2010.

(51) Int. Cl. G06F 3/048

(52) U.S. Cl. 715/763

(57) ABSTRACT

A system to assemble, design, and package content and features toward the creation of an application and/or publication for a mobile device; a system to allow the templatized production of an application and/or publication for a mobile device; a system to allow the immediate distribution of an application and/or publication for a mobile device; a system to allow the system to allow the updating of an application and/or publication for a mobile device; a system for accepting, deploying, and monetizing application and/or publication templates created by first and third-party entities.

This application claims the benefit of priority under 35 U.S.C. Section 119(e) of U.S. Provisional Application Ser. No. 61/393,671, filed Oct. 15, 2010, which is hereby incorporated by reference in its entirety.

### FIELD OF THE INVENTION

The present invention relates to improvements in the creation of mobile applications and more particularly to a computer-implemented system for assembling, designing, and publishing applications and publications such as delivered through a distributed computer network.

### BACKGROUND OF THE INVENTION

There are challenges associated with creating mobile applications, particular when trying to deliver them through a distributed computer network such as the Internet. Attendant with creation of such applications is the need to assemble resources, design the application for the platform, and publish to the platform. The present invention addresses these challenges.

### SUMMARY OF THE INVENTION

In accordance with one aspect of the invention, a computer-implemented system for the creation of mobile applications comprises an application server having a processor, a memory and a connection to a distributed computer network. A database stores content that is provided to the server. Code executing in the processor and operative to configure the processor to present a template selection to the user at a remote electronic device via the connection, receive a template selection from the user at the remote electronic device, receive content from the remote electronic device, process the content using an algorithm that matches the content to other data on the basis of a context of the content to the template and includes the content in the contextually matched location within the template, permit updates by the user to the content and the format of the content within the template in real time, and publish an application or publication that includes the content and a user-selected template by pushing at least one of content and one or more scripts to client devices.

This and other aspects of the invention can be appreciated from the accompanying description and drawing figures.

### BRIEF DESCRIPTION OF THE DRAWING FIGURES

FIG. 1. illustrates a schematic diagram of a system for creating mobile applications in accordance with one embodiment of this invention.

FIG. 2. illustrates, within a conventional browser application, a user interface component to facilitate the selection of a use-specific template in accordance with an embodiment of this invention.

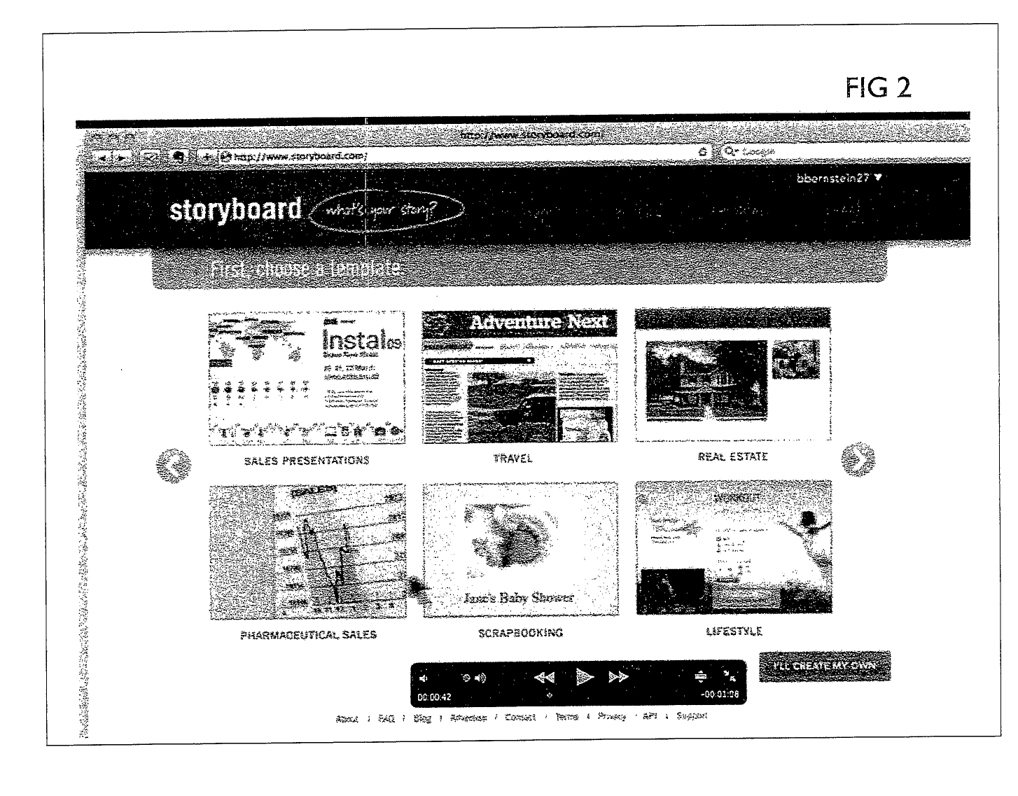

FIG. 3. illustrates an example of a user interface component that is configured to initiate mobile application creation session with a user.

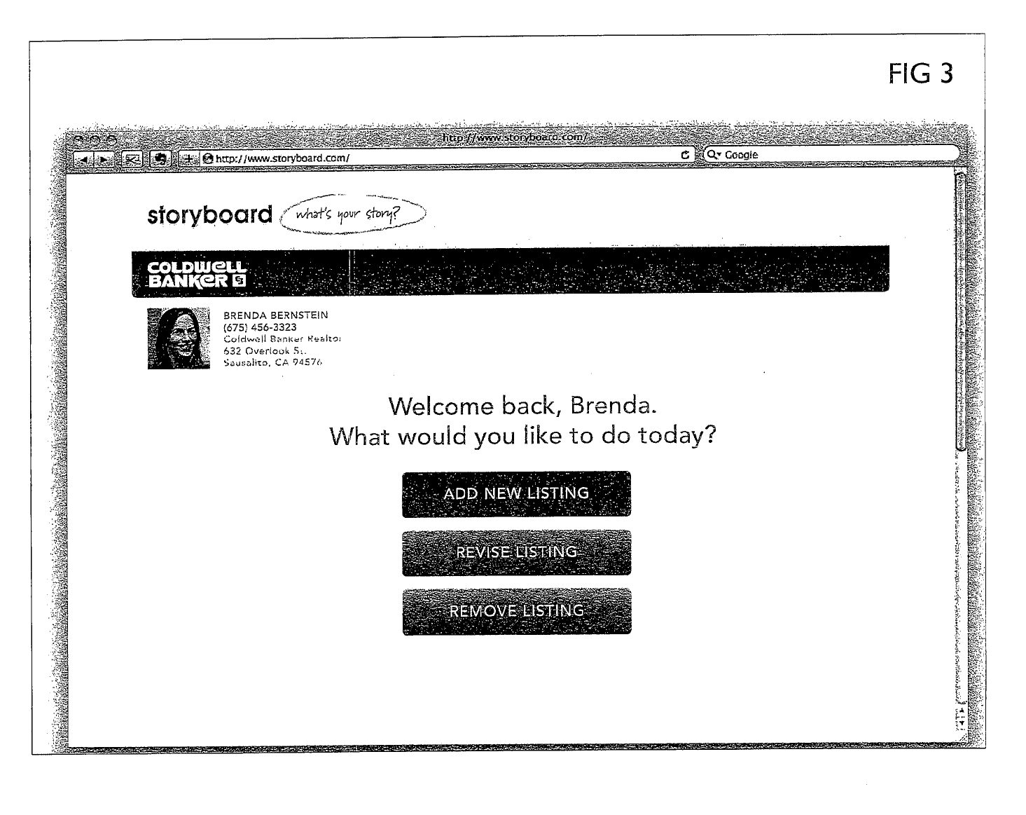

FIG. 4. illustrates an example of a user interface component that is configured to accept user defined inputs and subsequent server call to retrieve content, toward the creation of a mobile application.

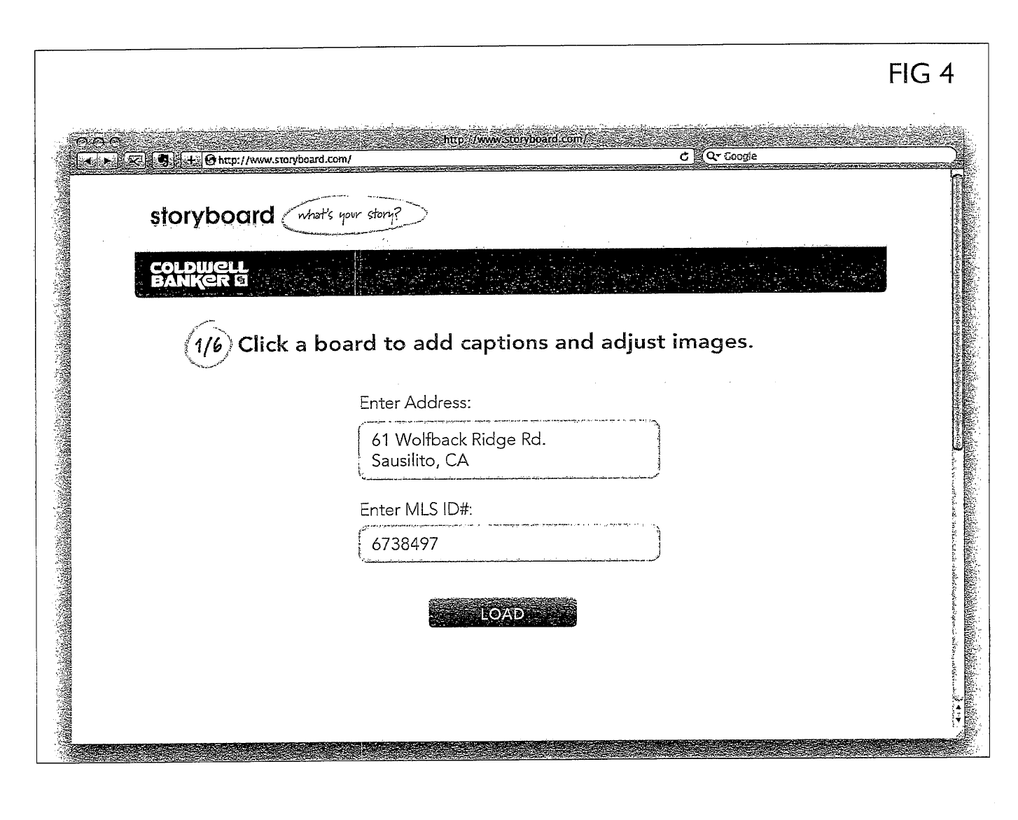

FIG. 5. illustrates an example of a user interface component that is configured to import user-specified content toward the creation of a mobile application.

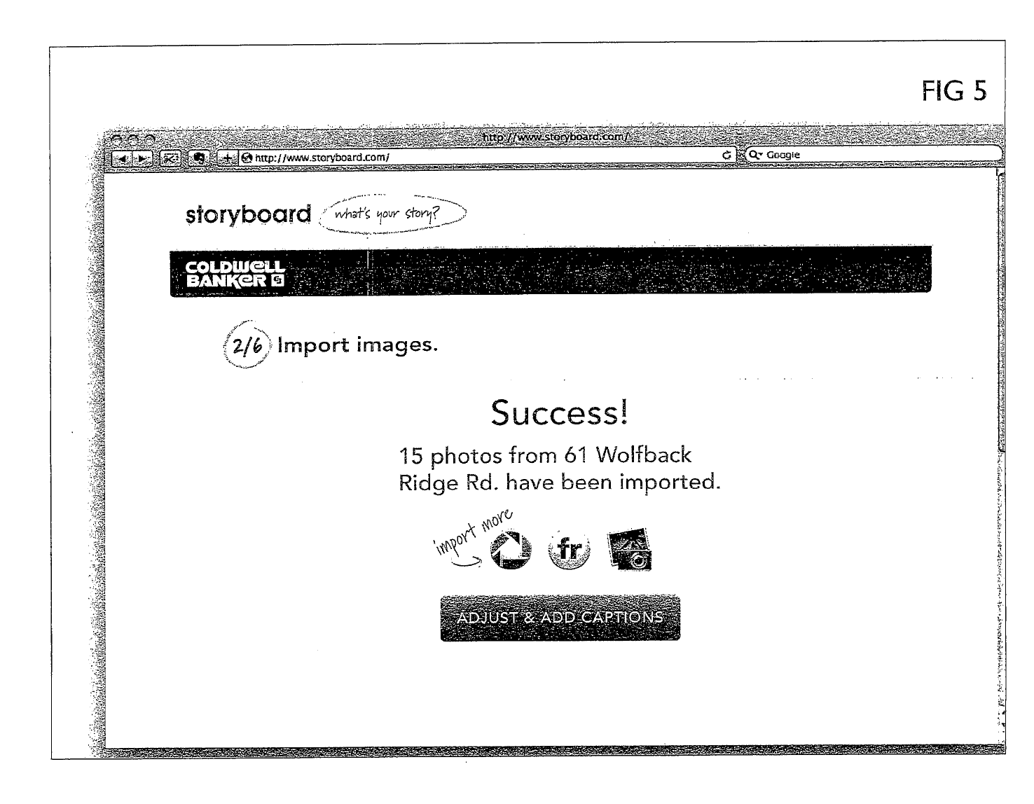

FIG. 6 illustrates the machine application of content to a business-category specific template, in accordance with one embodiment of this invention.

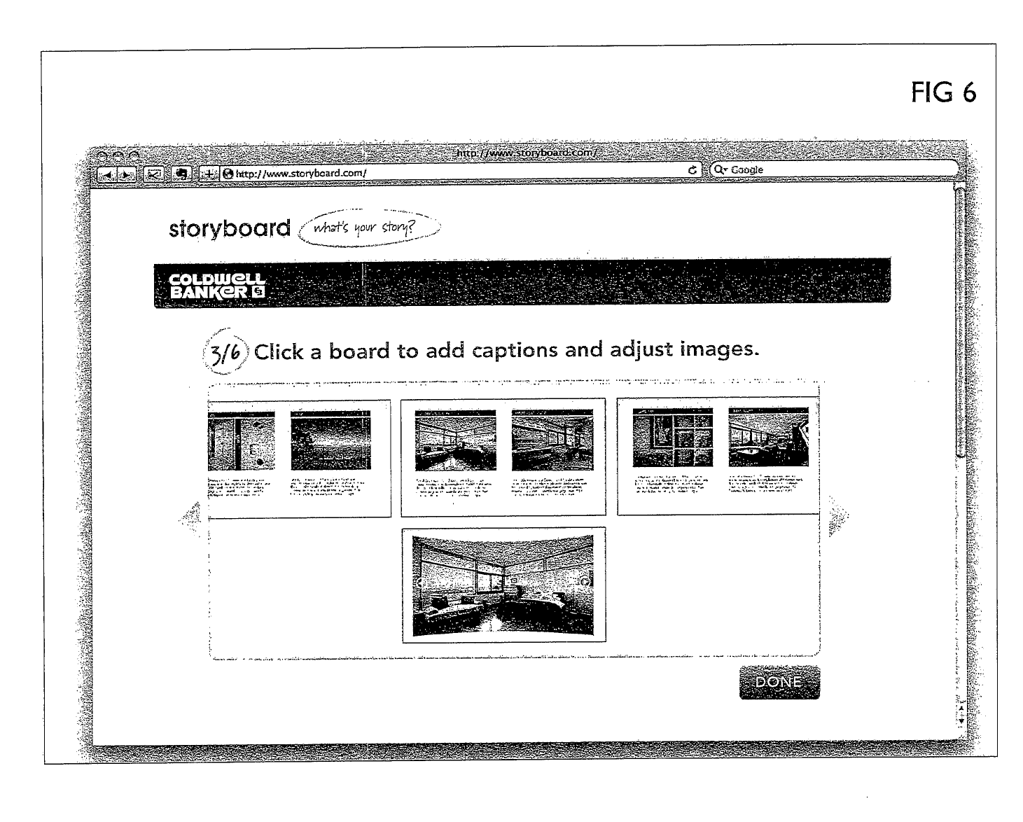

FIG. 7 illustrates a content editing and customization suite that permits manual editing and customization of content display, ordering, organization, and narration in accordance with one embodiment of this invention.

FIG. 8 illustrates the machine application of externally-sourced, contextually relevant content from a server.

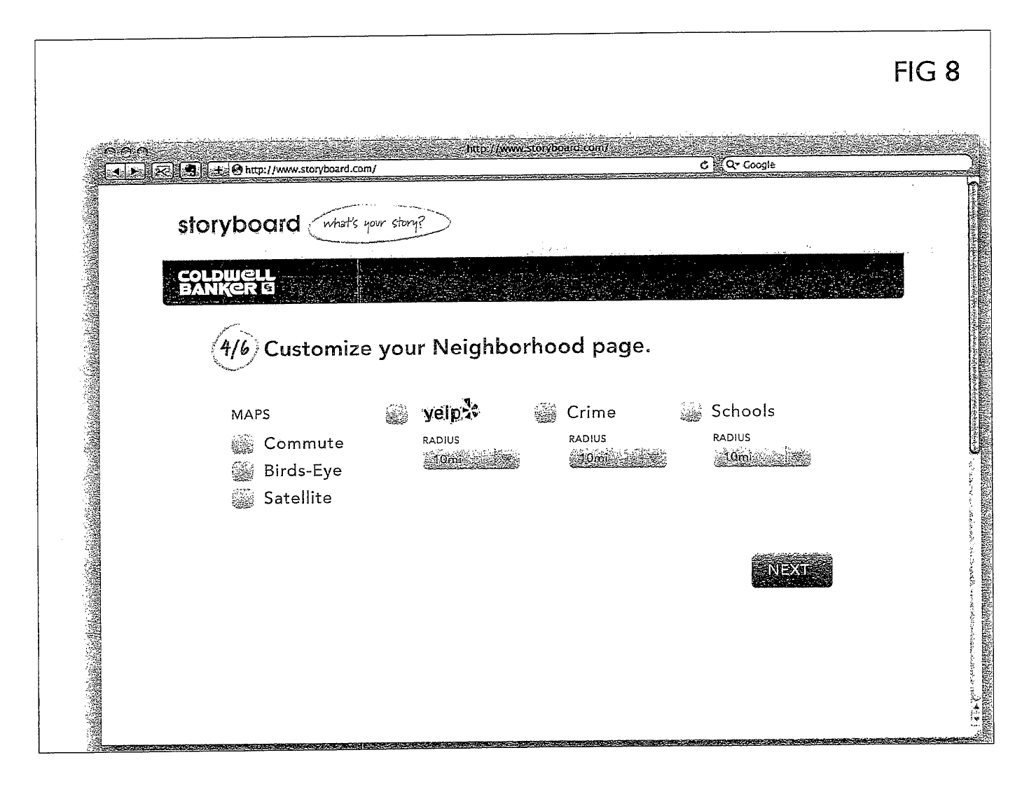

FIG. 9 illustrates an example of a user interface that is configured to execute the creation of the mobile application, in accordance with one embodiment of this invention.

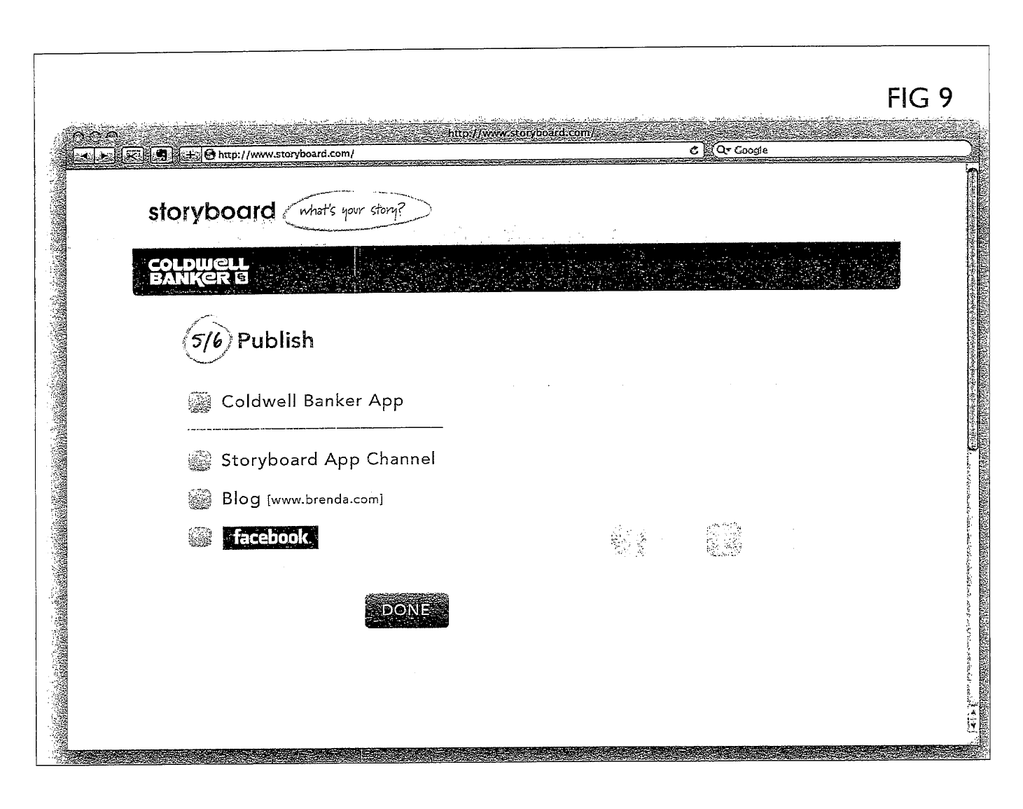

FIG. 10 illustrates an example of a user interface that is configured to distribute via social media the mobile application, in accordance with one embodiment of this invention.

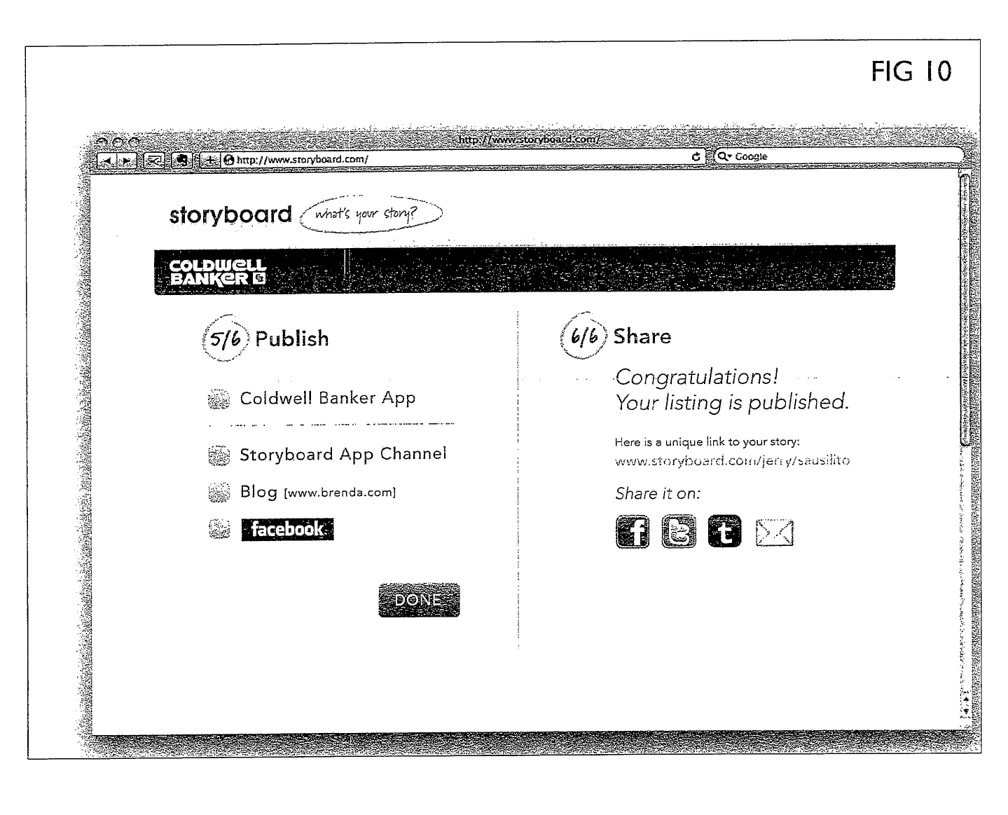

FIG. 11 illustrates an example of user interface on a mobile device wherein the created application is activated by the user.

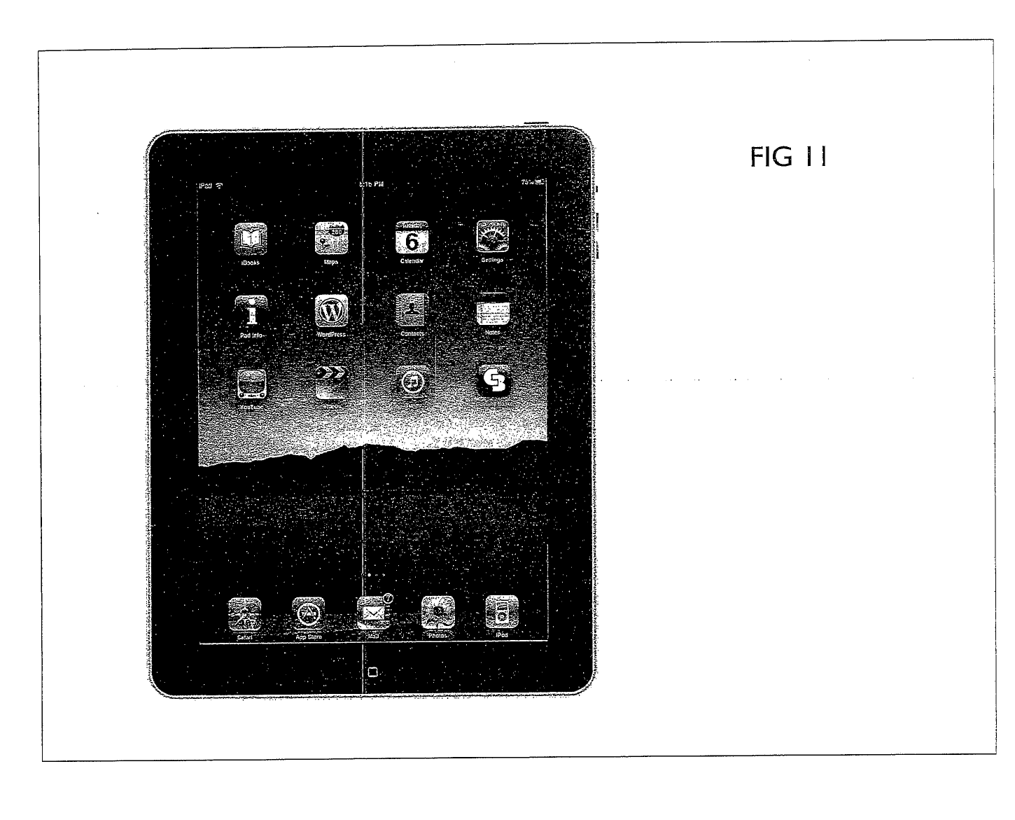

FIG. 12 illustrates an example of the application and user-selected content as displayed on a mobile device, in accordance with one embodiment of this invention.

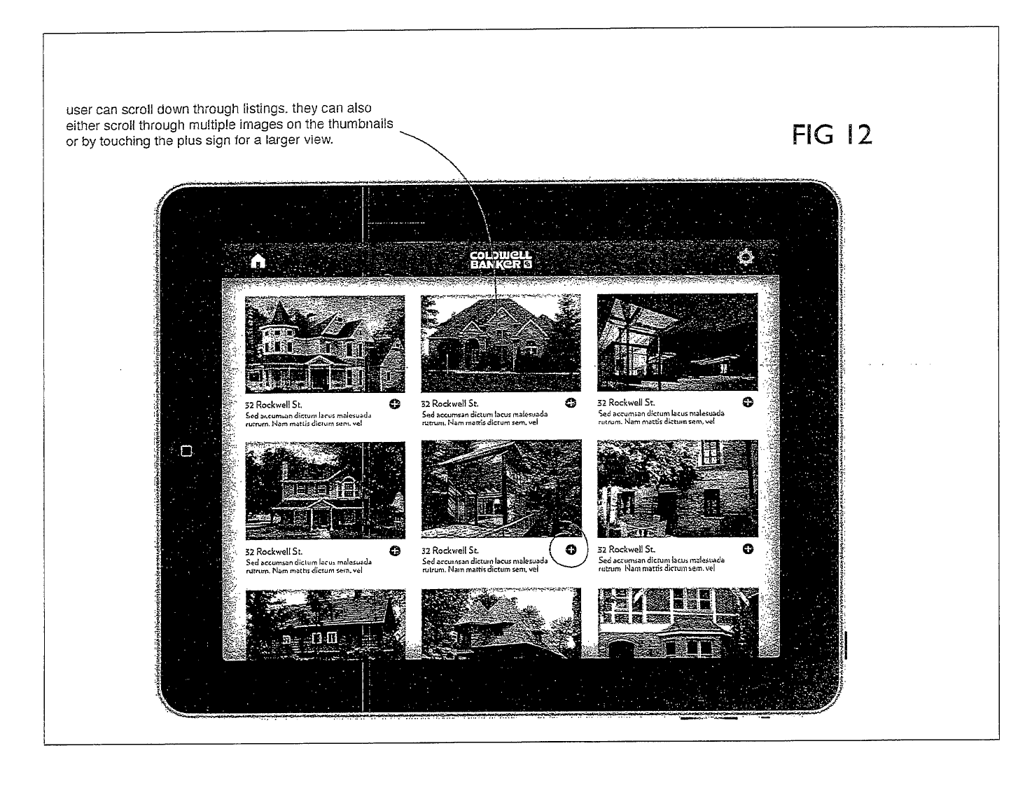

FIG. 13 illustrates a user interface component that is an element of a user-selected, business-category specific template used to display content, in accordance with one embodiment of this invention.

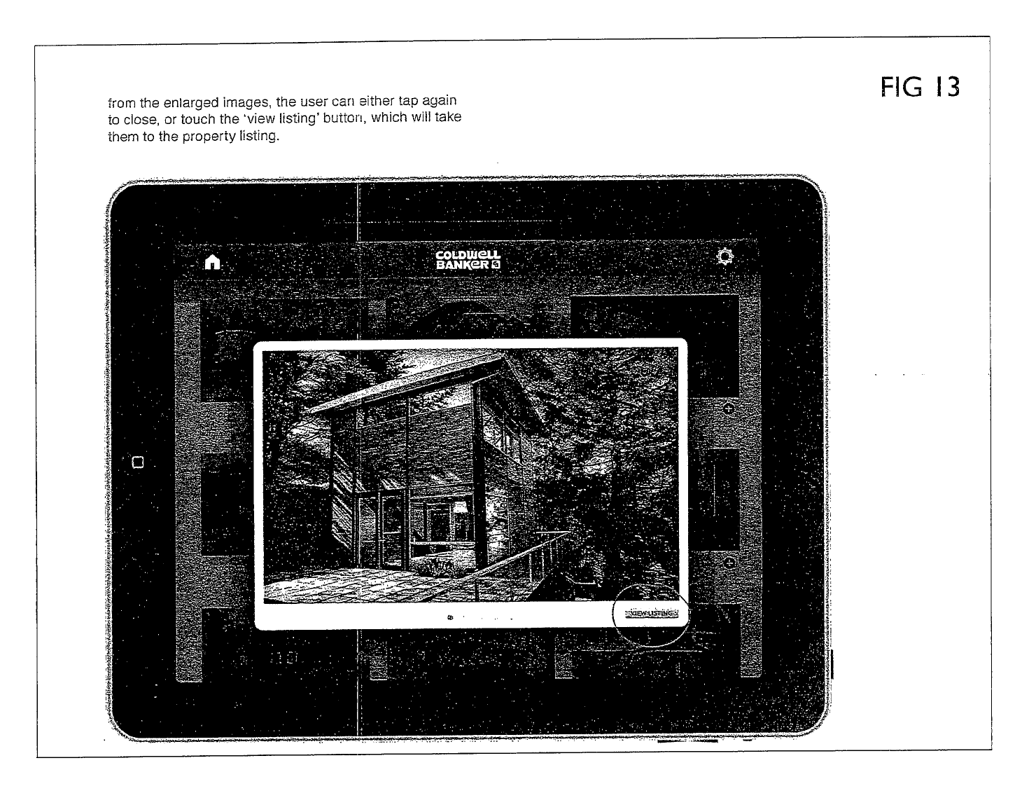

FIG. 14 illustrates a user interface component that is an element of a user-selected, business-category specific template used to display content, in accordance with one embodiment of this invention.

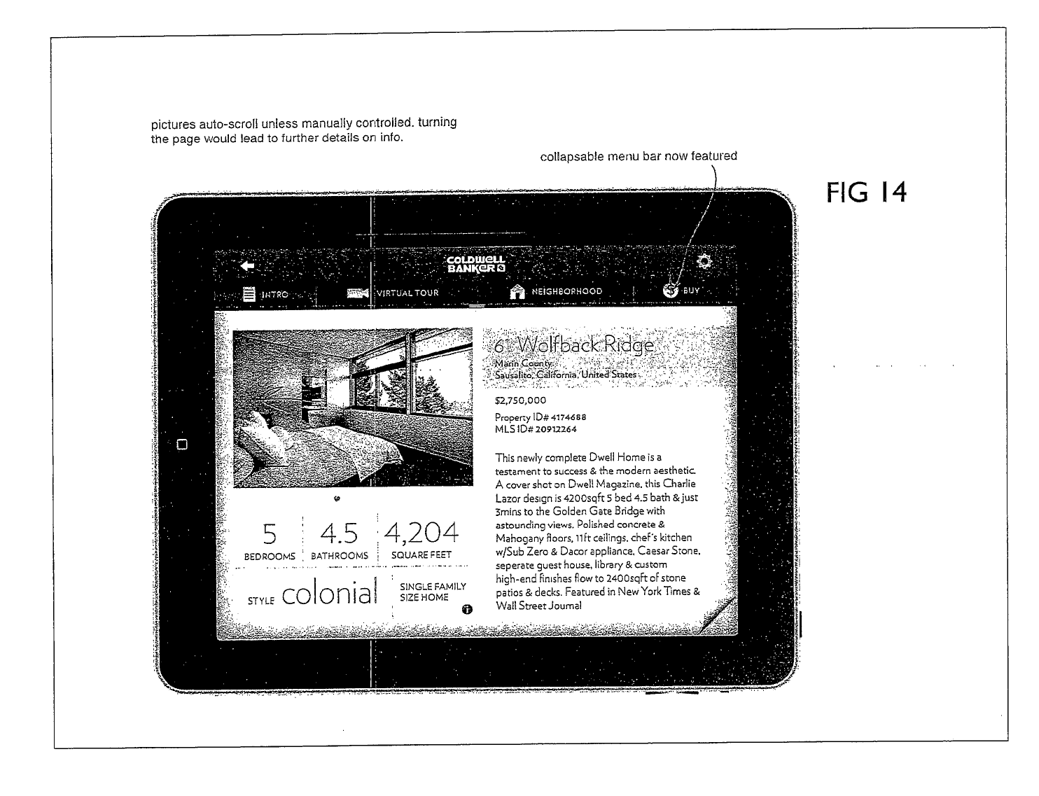

FIG. 15 illustrates a user interface component that is an element of a user-selected, business-category specific template used to display content, in accordance with one embodiment of this invention.

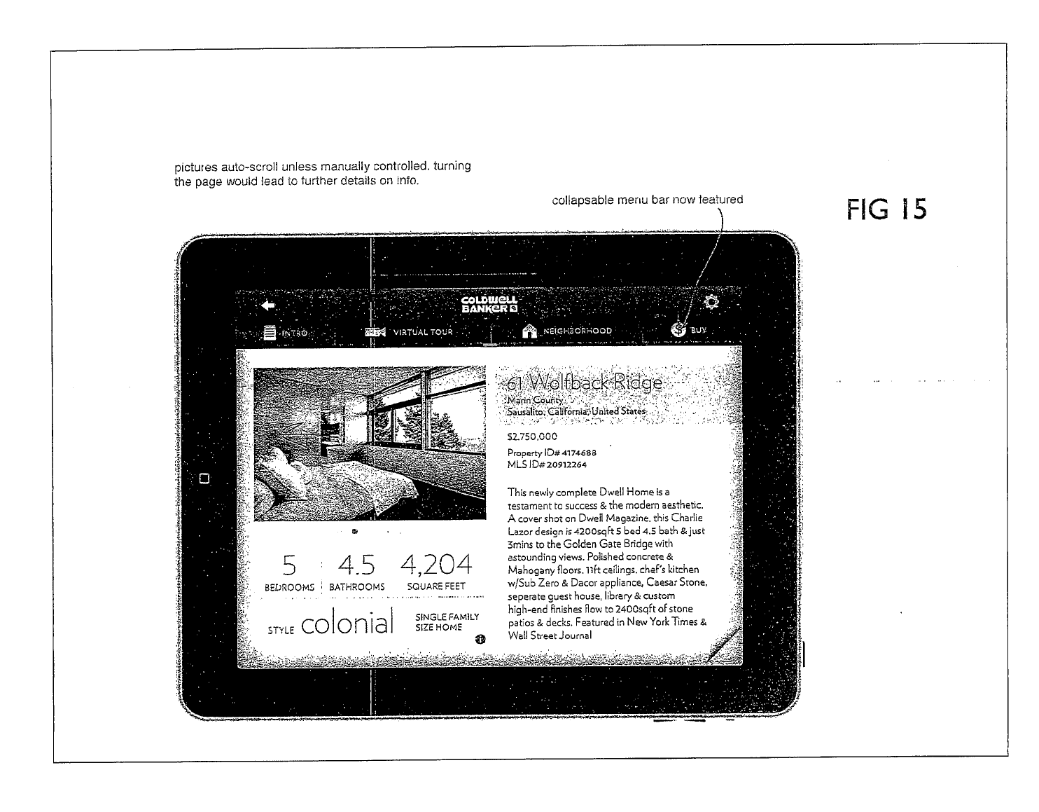

FIG. 16 illustrates a user interface component that is an element of a user-selected, business-category specific template used to display content, in accordance with one embodiment of this invention.

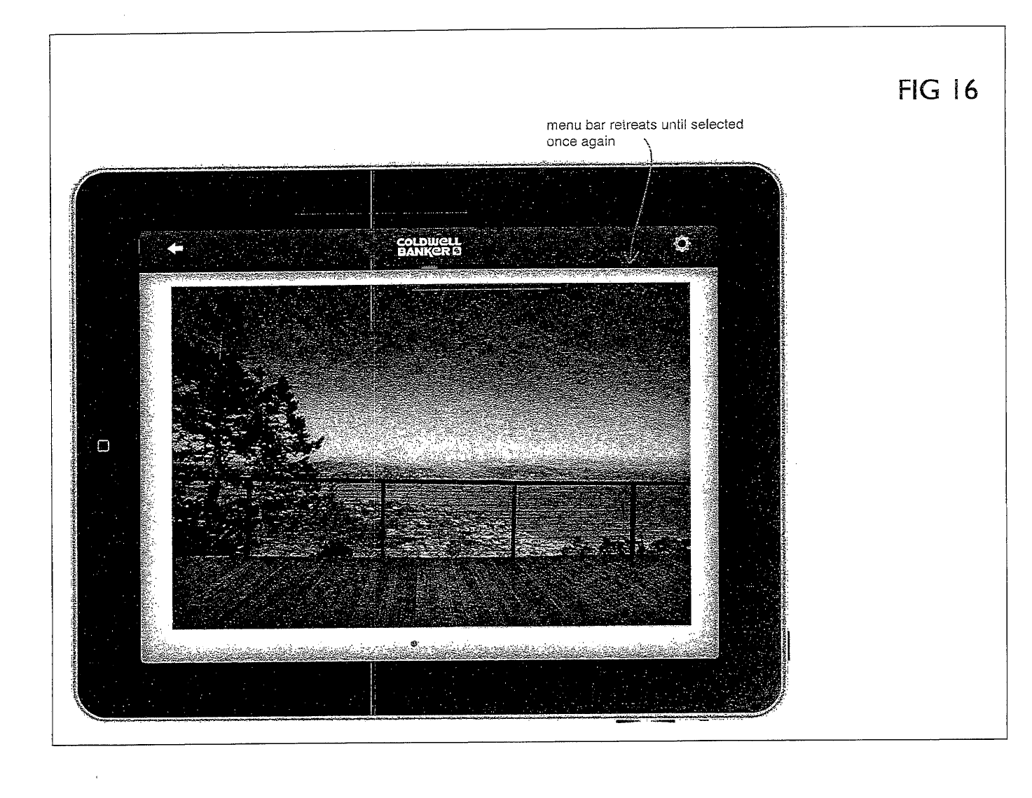

FIG. 17 illustrates a user interface component that is an element of a user-selected, business-category specific template used to display content, in accordance with one embodiment of this invention.

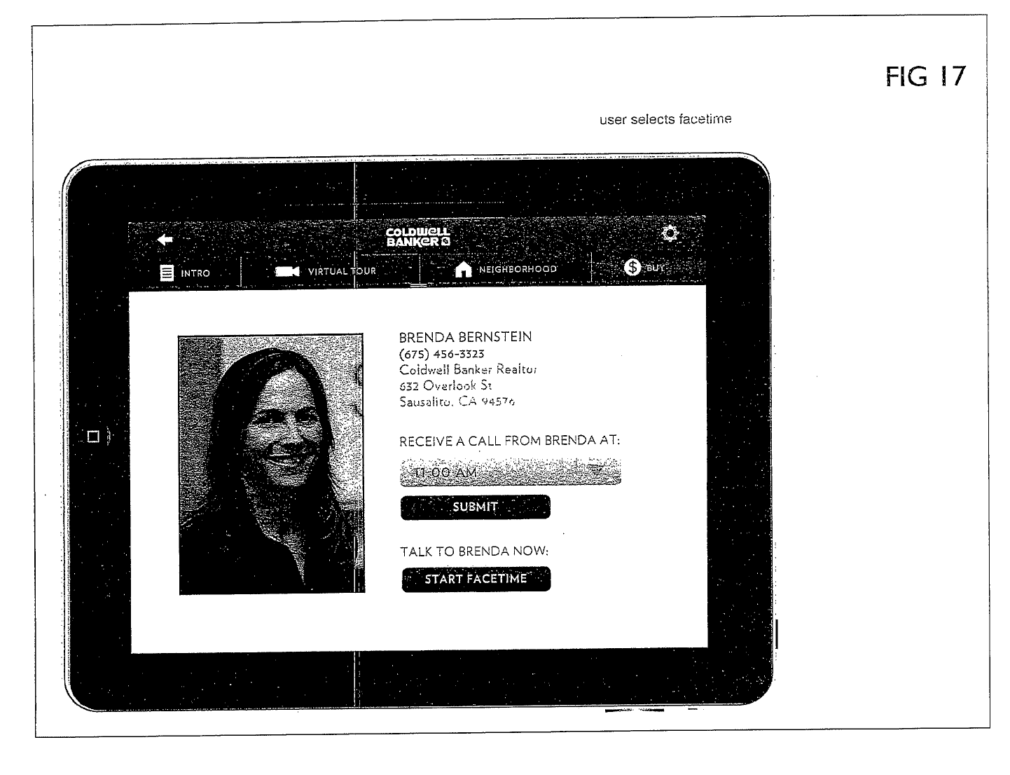

FIG. 18 illustrates a user interface component that is an element of a user-selected, business-category specific template used to display content, in accordance with one embodiment of this invention.

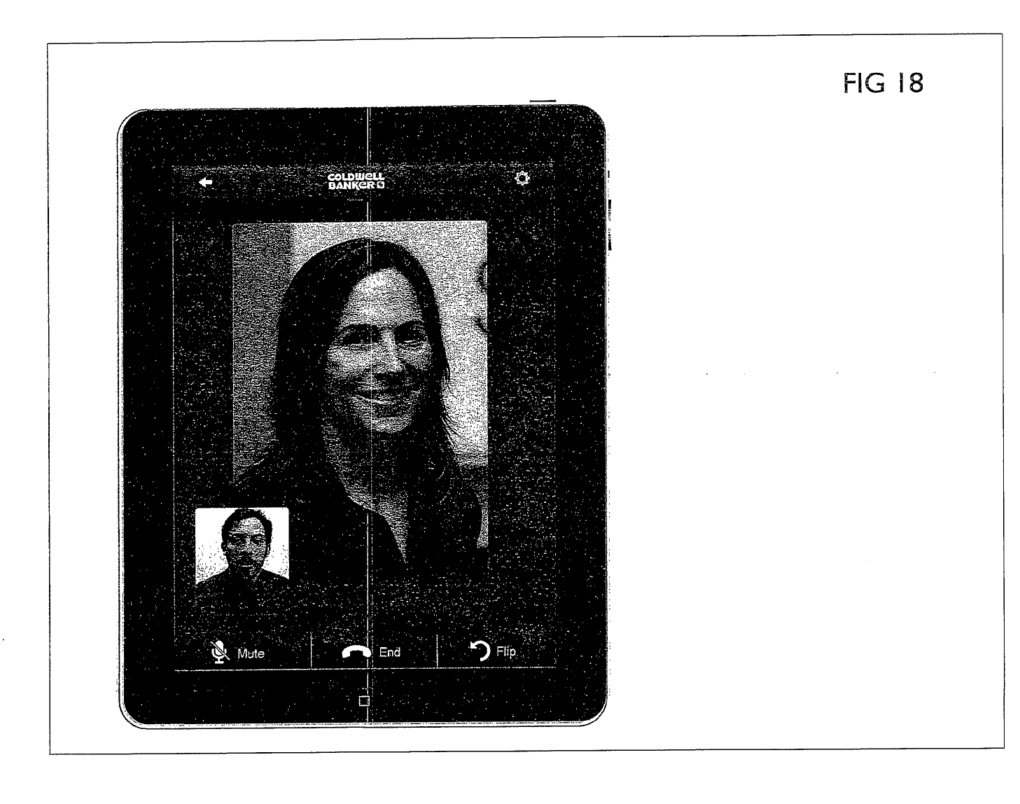

FIG. 19 illustrates a user interface component that is an element of a user-selected, business-category specific template used to display content, in accordance with one embodiment of this invention.

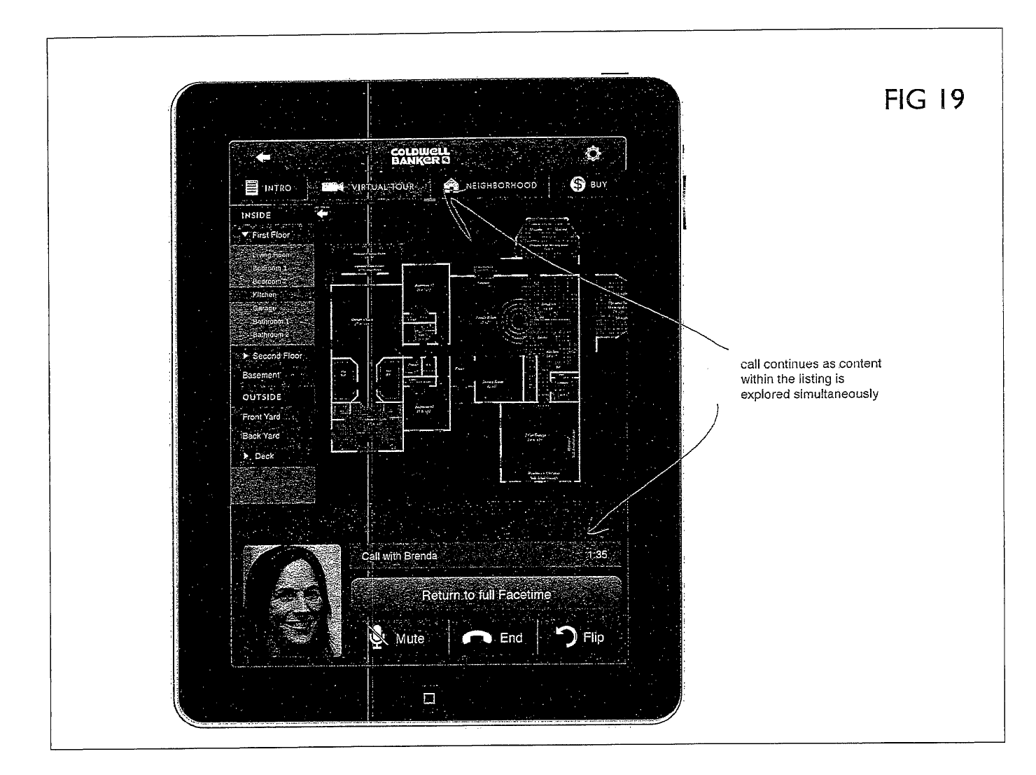

FIG. 20 illustrates a user interface component that is an element of a user-selected, business-category specific template used to display content, in accordance with one embodiment of this invention.

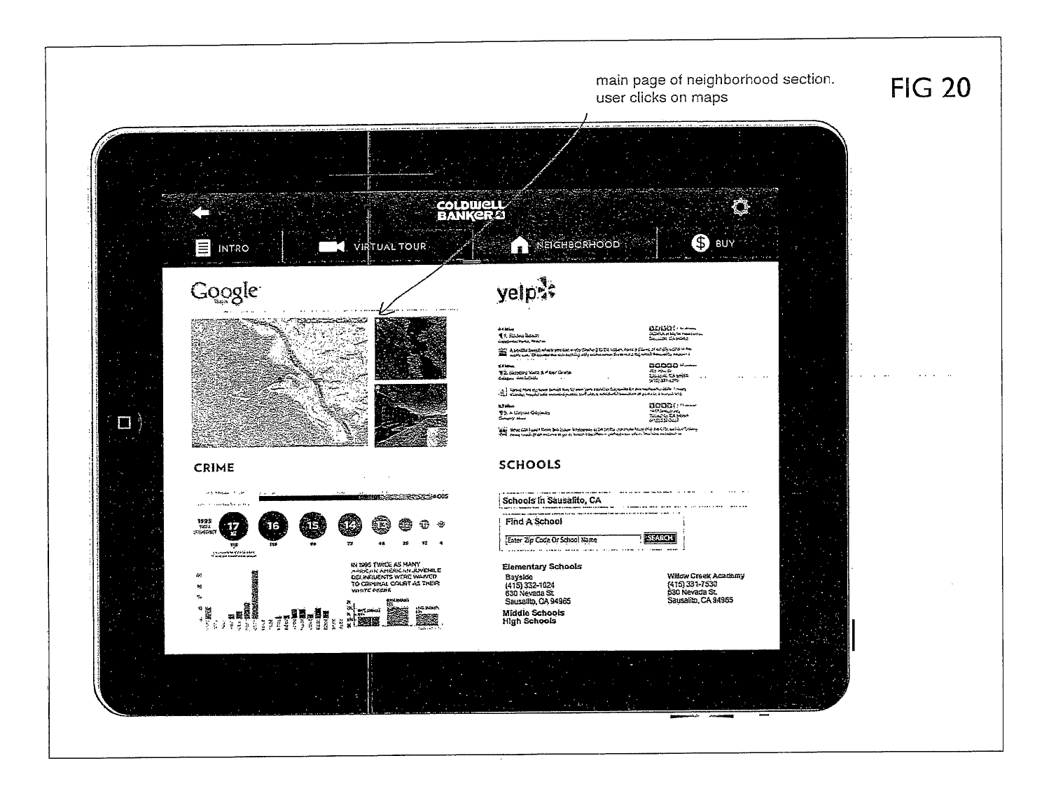

FIG. 21 illustrates a user interface component that is an element of a user-selected, business-category specific template used to display content, in accordance with one embodiment of this invention.

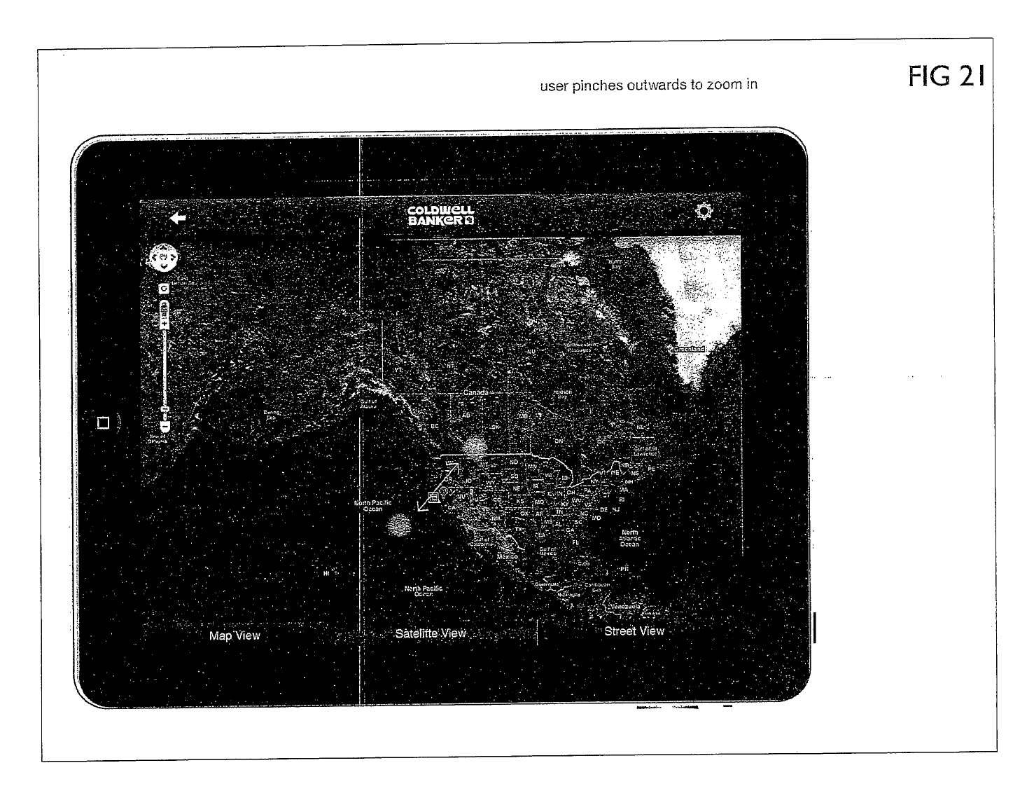

FIG. 22 illustrates a user interface component that is an element of a user-selected, business-category specific template used to display content, in accordance with one embodiment of this invention.

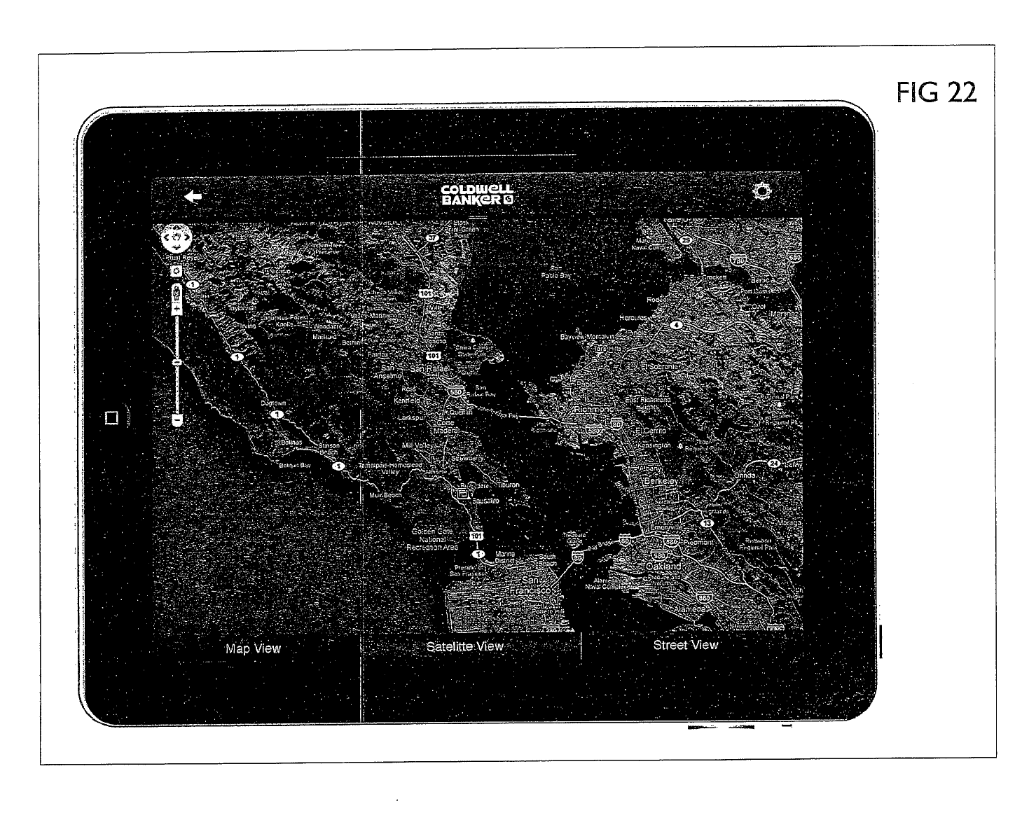

FIG. 23 illustrates a user interface component that is an element of a user-selected, business-category specific template used to display content, in accordance with one embodiment of this invention.

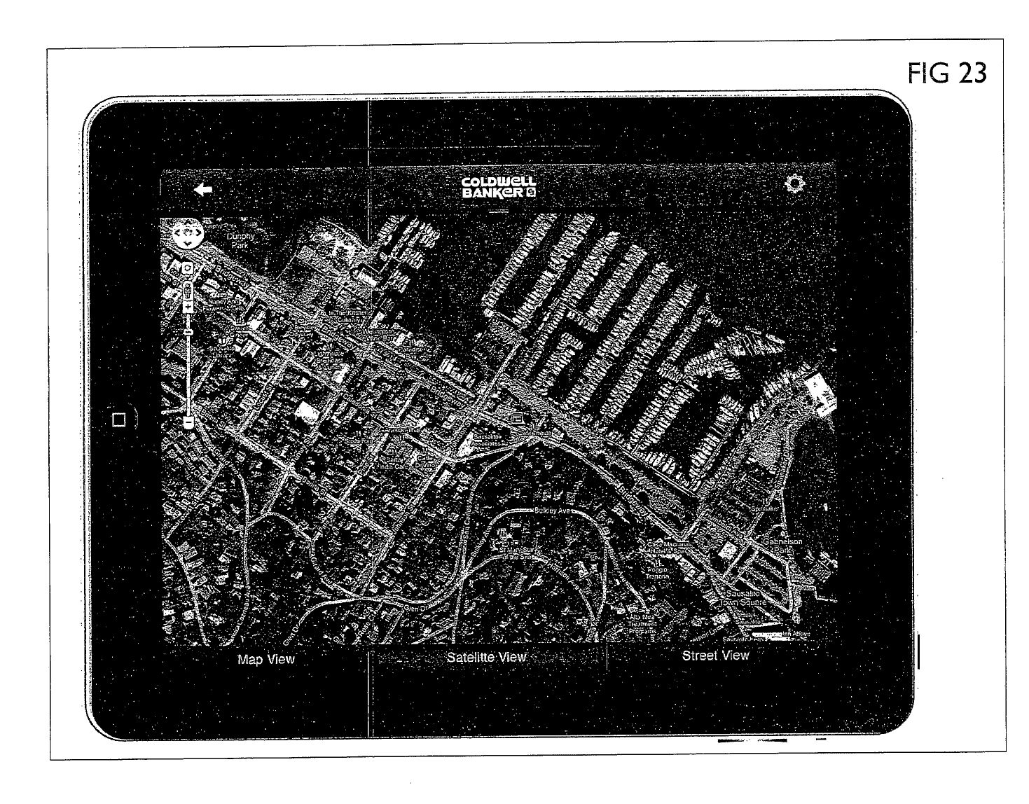

FIG. 24 illustrates a user interface component that is an element of a user-selected, business-category specific template used to display content, in accordance with one embodiment of this invention.

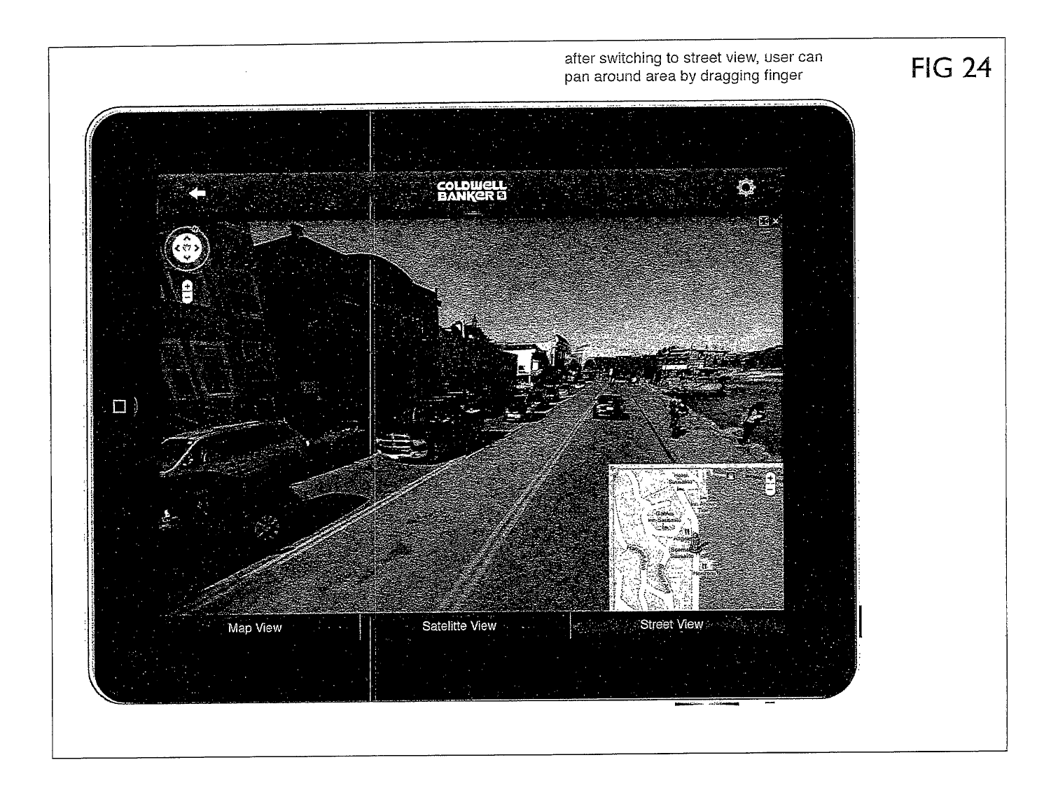

FIG. 25 illustrates a user interface component that is an element of a user-selected, business-category specific template used to display content, in accordance with one embodiment of this invention.

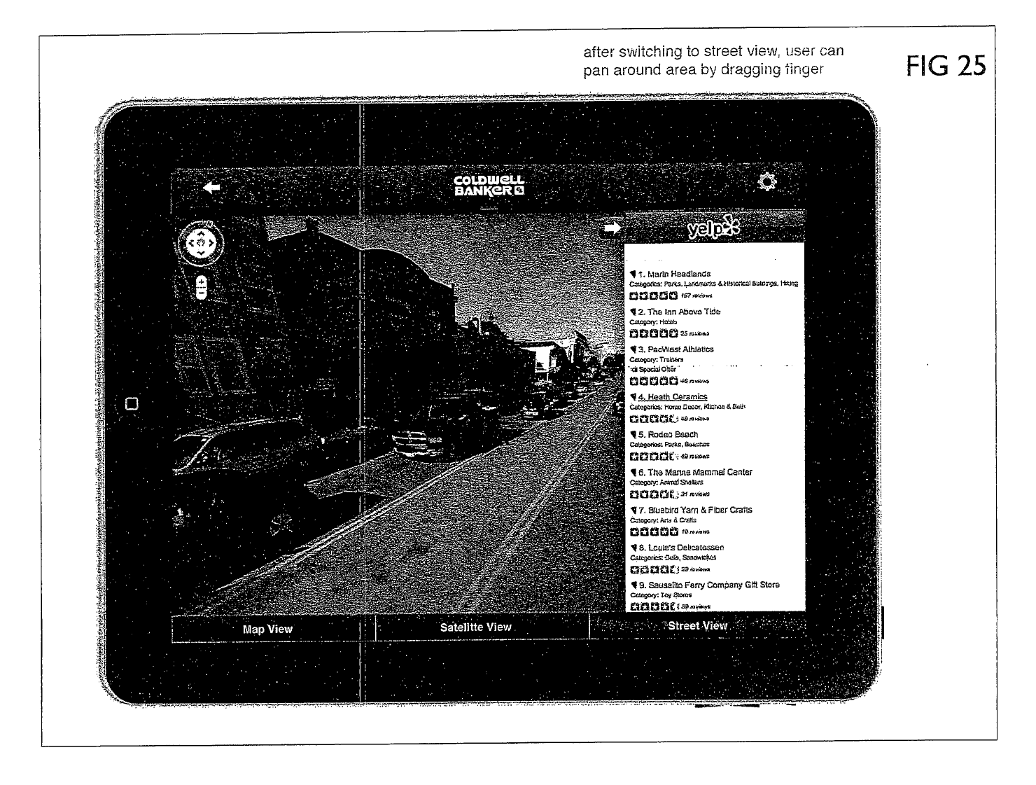

FIG. 26 illustrates a user interface component that is an element of a user-selected, business-category specific template used to display content, in accordance with one embodiment of this invention.

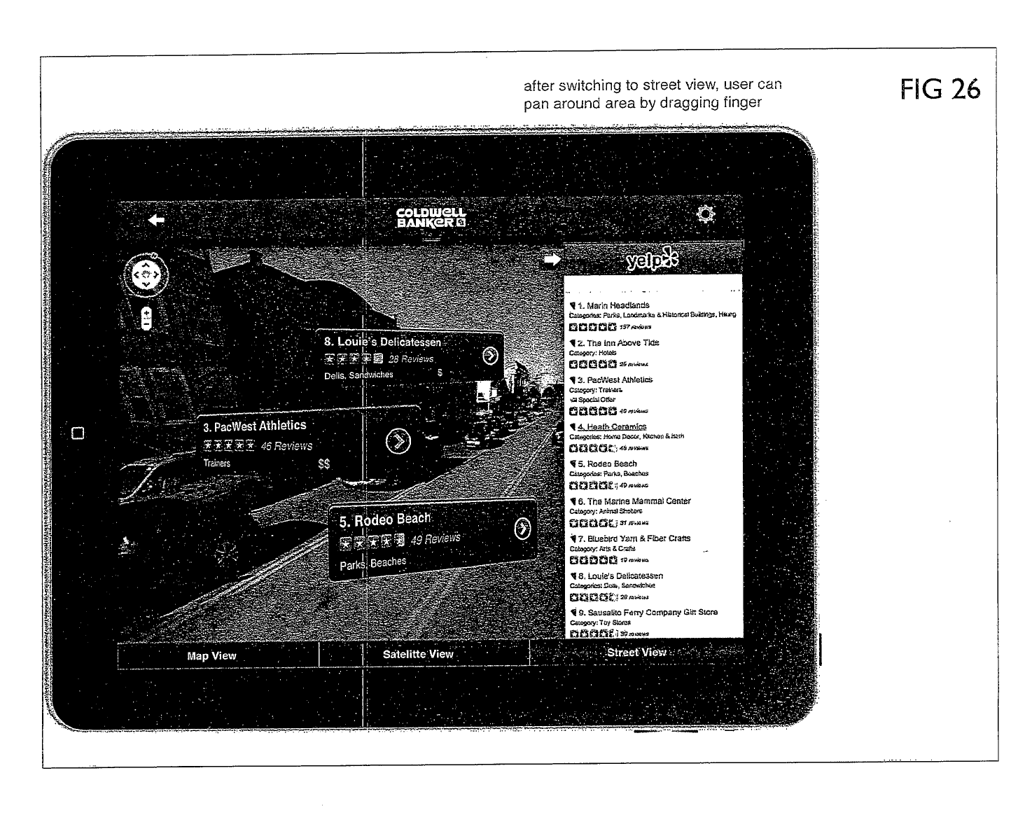

### DETAILED DISCLOSURE OF CERTAIN EMBODIMENTS OF THE INVENTION

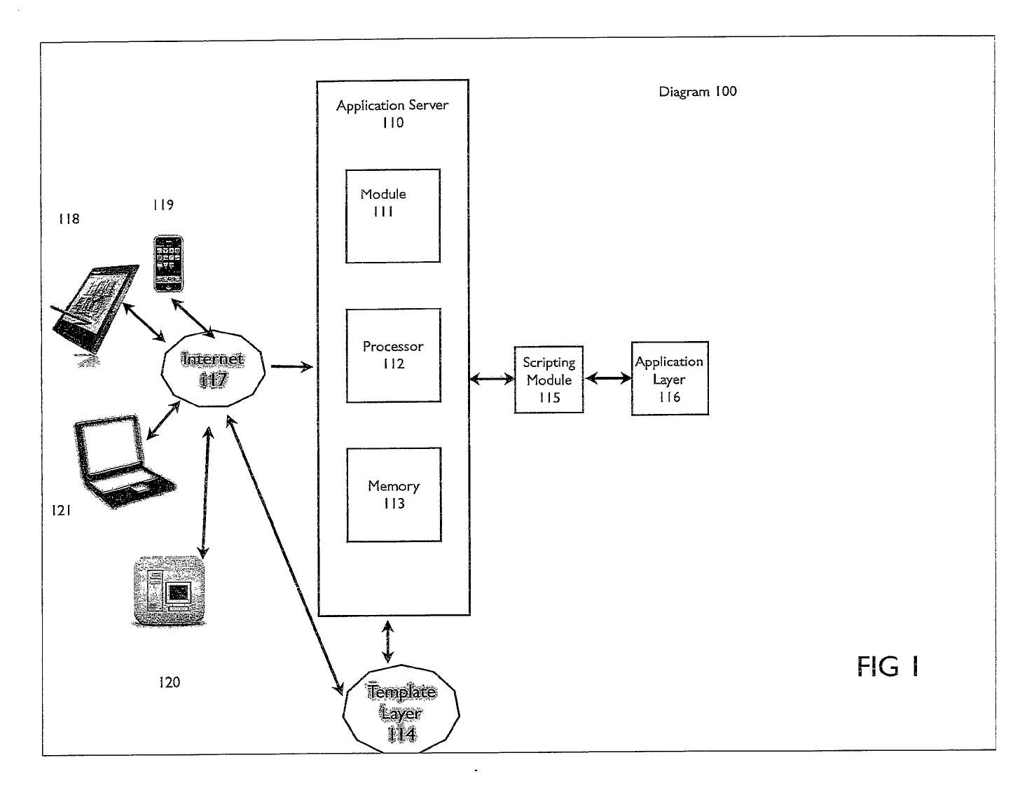

In accordance with a broad aspect of the invention, embodiments are described of a computer-implemented system for the creation of mobile applications and for the publication of content to mobile devices. FIG. 1 illustrates a system diagram 100 that utilizes an application server 110 (server). The server hosts different software modules and peripheral devices. The server includes a processor 111, a processor 112, and memory 113. The memory stores data and instructions from the code modules that are extracted by the processor. Implementation of the memory can be any conventional storage media such as a magnetic tape, an optical storage media, a compact disc, or a floppy disc. Alternatively, the memory can be a random access memory, a read only memory, or other type of electronic storage. The memory, at least in part, can be located on a remote storage system.

The server 110 is communicatively coupled to a distributed computer system such as the Internet 117. Communications comprise conventional, bidirectional transmission of information between the server, other resources 114, 115, 116, 117, and client computers 118, 119, 120, 121. For instance communications can be over plural network segments, both public and private, and can include both wired and wireless networks. A variety of protocols can be used for the communications; the communications mechanism can be conventional as it forms no part of the present invention.

Users interested in gaining the functionality provided by the application server 110 access the server through internet 117 from a client device (“client”) such as clients 118, 119, 120, or 121. The clients comprise machines of conventional construction such as the devices illustrated in FIG. 1: a handheld device in 119; a tablet device in 118, a laptop computer in 121, and a desktop computer in 120. Each client has a processor, memory and at least one input/output device such as a keyboard and a display. The user can create applications and publications with user selected content, bundles of content, publications on one or any of these clients.

Use of the application server through the clients also permits the user to create publications (comprised text, photos, video, music, narration, etc.) for display within applications on client devices.

The application server also allows users, via a client, to update in real time the contents of an application and/or publications created on the application layer. Any client device can be used to input updates.

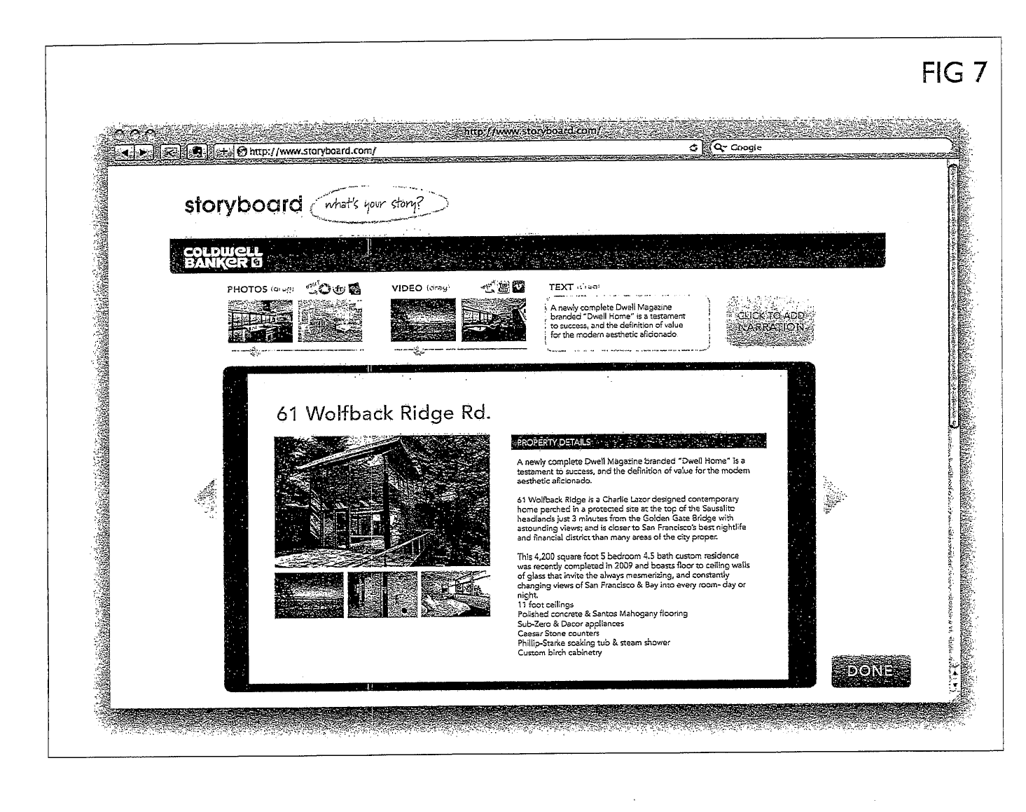

The application server processes content uploaded by the client and through a machine algorithm matches it to contextually appropriate sources of data. For instance, FIG. 7 illustrates content that has been added and matched to other data on the basis of its context, and in relation to the template itself so that the content is in a contextually matched location within the template.

Users creating an application and/or publication select, via the application layer, a template 114 appropriate to their needs. Templates are pre-fabricated and incorporate elements of design, navigation, and user experience bespoke to a given client. Included in these clients is a tablet computer (e.g. Apple iPad). Through the client and via the application layer, the user then imports, lays out and formats the content. The application layer then processes this application and/or publication and through the scripting module 115 creates a script. In part, the content management system, through code that configures the processor, can support the architecting and layout of content on navigable X, Y & Z axes.

Templates available in the template layer 114 are vertical-specific, and can be created by external creators and licensed for profit.

The script, which contains or links to the content selected by the user and formatted according the business logic prescribed by the user-selected template, is made available to the clients for display or play.

On consumer prompting (activation of the application and/or publication), the client then solicits the script and displays it in the application layer. The application layer can be a downloadable player that lives on the client.

The consumer can then use the client's user interfaces (touch pad, mouse, etc) to navigate the application and/or publication. Navigation can be extended to communications between a user and an individual (e.g., facetime, skype, cellular call, and any of a variety of messaging services).

Using the client, via the application, the user can change the content of the application and/or publication. Changes made to the application and/or publication create a new script which is then pushed to the consumer's client device.

I claim:

1. A computer-implemented system for the creation of mobile applications and/or the publication of content to mobile devices, comprising:
an application server having a processor, a memory and a connection to a distributed computer network;
a database to store content;
code executing in the processor and operative to configure the processor to:
present a template selection to the user at a remote electronic device via the connection;
receive a template selection from the user at the remote electronic device;
receive content from the remote electronic device;
process the content using an algorithm that matches the content to other data on the basis of a context of the content to the template and includes the content in the contextually matched location within the template;
permit updates by the user to the content and the format of the content within the template in real time; and
publish an application or publication that includes the content and the user-selected template by pushing at least one of content and one or more scripts to client devices.

2. The system of claim 1, wherein the templates presented for selection to the user are pre-fabricated and incorporate elements of design, navigation, and user experience bespoke to a given client device.
